(19) United States
(12) Patent Application Publication
(10) Pub. No.: US 2011/0236621 A1
(43) Pub. Date: Sep. 29, 2011

(54) INSULATED BLANKET FOR OPENINGS

(76) Inventor: Robert B. Sampson, Nashua, NH (US)

(21) Appl. No.: 13/070,001

(22) Filed: Mar. 23, 2011

Related U.S. Application Data
(60) Provisional application No. 61/317,441, filed on Mar. 25, 2010.

(51) Int. Cl. B32B 3/06

(52) U.S. Cl. 428/99

(57) ABSTRACT

An insulating cover device is comprised of a multi-layered blanket material. The multi-layered blanket material is outfitted with an attachment member, wherein a first portion of the attachment member is connected to the multi-layered blanket material and a second portion of the attachment member is applied to a surface surrounding an opening. The first portion of the attachment member located on the multi-layered blanket material is then connected to the second portion of the attachment member, thereby creating a seal that prevents air passing from one side to the other side. The attachment member is secure, but can be removed, opened and closed to provide access to the opening as needed.

### CROSS-REFERENCE TO RELATED APPLICATIONS

This application claims the benefit of U.S. Provisional Application Ser. No. 61/317,441, filed on Mar. 25, 2010 entitled “Insulated Blanket For Openings”, which is hereby fully incorporated by reference.

### TECHNICAL FIELD

The present invention relates to insulated cloth materials and more particularly, to a multi-layered insulated cloth material device that can be used to cover openings and fill gaps where standard insulation is not tolerable.

### BACKGROUND

Traditional insulation products are generally constructed from fiberglass, foam, cellulose or the like. Fiberglass has been widely used in walls, ceilings and floors in areas where the insulation can be covered with a wall covering or ceiling covering material. Exposure to fiberglass insulation and the particles that can be broken off may be toxic and may cause irritations when the material makes contact with skin or eyes.

There are many areas in a home where it is not possible to cover the insulation with a wall or ceiling or flooring material. Once such example is an attic opening. Moreover, areas such as attic openings do not lend themselves to being covered with such materials. The attic opening may have foldable stairs that come down or the attic opening may have to be accessed to allow a ladder to be placed up through the opening in order to gain access to the attic space. When this opening is covered, it is often covered with a ceiling tile, a piece of wood, or other similar application. These types of coverings offer a very low R value and generally do not provide sufficient insulation. Many times the opening is not covered or the covering leaves a gap around the perimeter of the opening. As a result, the effect is as if a homeowner had a window open. Valuable heat is lost and drafts are present, which leads to significant amounts of wasted energy and higher heating and cooling bills.

The attic opening is an area of home heat loss and air escape that is overlooked by many homeowners. It is important that this area be sufficiently insulated, as the attic access panel is what separates the conditioned air of the house (heated or cooled) from the outside air present in an attic.

Windows and doors can be caulked and weather-stripped, but there is not an easy remedy to close off the larger air leak of an attic access panel. Some homeowners will cover the area with fiberglass insulation, but when the access panel is opened, fibers will break off and enter the air. Also, it is difficult to maintain a secure seal when the attic access panel is opened and closed. Other homeowners may construct a foam box to cover the opening. These boxes can be difficult to construct and put into place and also tend to have gaps and spaces between the foam and the attic opening that lead to air leaks. Many other potential solutions have been proposed and many are expensive and installed only by skilled trades people. Additionally, many existing products cover only specified size openings and are not adaptable to unusual openings or custom sizes.

As such, there is a need to improve upon the prior art to create an inexpensive insulated blanket for attic openings that can be easily applied by a homeowner. The device should provide sufficient insulation and air barrier to significantly reduce or eliminate air loss.

### SUMMARY OF THE INVENTION

The present invention features a multi-layered blanket material that is flexible and easily attachable and detachable to an attic opening or another household opening. The material reduces the flow of energy and air through the attic opening. The multi-layered blanket will not interfere with the attic access panel or the pull down stairs. The multi-layered blanket can be installed by the homeowner without specialized tools. In a preferred embodiment of the present invention, the multi-layered blanket is constructed from a high-density fiber with a polyethylene moisture vapor barrier and a tight magnetic, hook and loop or other similar edge seal.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### DESCRIPTION OF THE DRAWINGS

These and other features and advantages of the present invention will be better understood by reading the following detailed description, taken together with the drawings wherein:

FIG. 1. is a perspective view of the multi-layered blanket material of one aspect of the present invention; and

FIG. 2. is a perspective view of the insulating cover device of one aspect of the present invention installed over an attic door for exemplary purposes.

### DESCRIPTION OF THE INVENTION

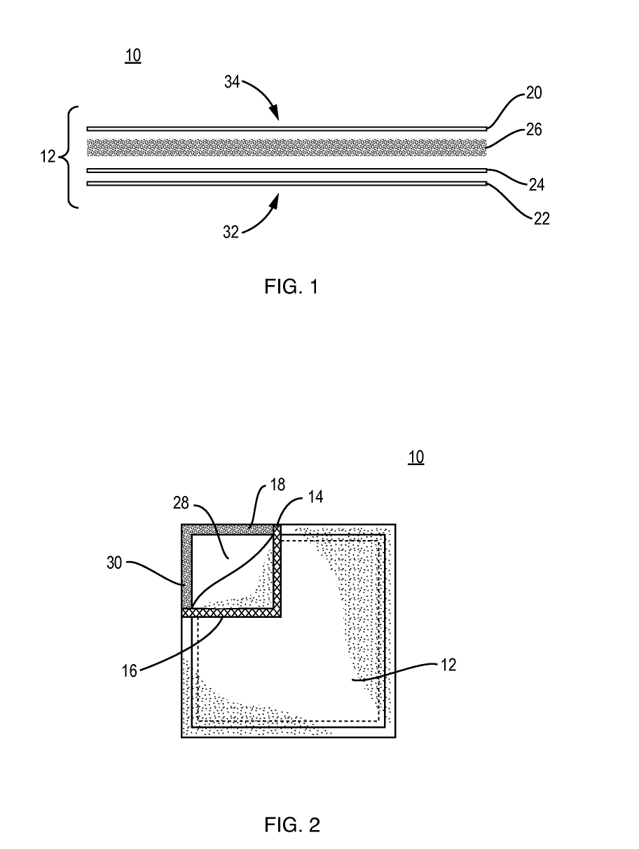

The present invention features an insulating cover device 10, FIGS. 1 and 2. The insulating cover device 10 can be of any size or shape to cover any opening, including preferable a gap or opening in a window or doorway. In one embodiment of the present invention, the insulating cover device 10 is constructed as a multi-layered blanket material 12, FIG. 1 with a first side 32 and a second side 34. Typically the second side 34 would be placed against the door or other opening to be insulated while the first side 32 would be facing the heated area.

The multi-layered blanket material 12 may be of any type such as, for example, available from The Warm Company™ in Lynnwood, Wash. The multi-layered blanket material 12 may comprise, for example, four layers, including a layer of reflective polyethylene 24 that provides a vapor proof barrier. The reflective polyethylene 24 may be a metalized poly film with air-trapping fibers. Another layer may consist of hollow polyester fibers 26 that resist conduction and provide a moderate R-value of approximately 5. The multi-layered blanket material 12 will also preferably contain an outer layer 20 and an inner layer 22. These layers 20 and 22 may be made from material such as Tyvek® from Dupont or any other material that can withstand normal wear and tear and present a vapor and air barrier, preferably a synthetic material. The use of multiple layers reduces the flow of air (and energy) through the material. The plurality of layers is preferably quilted together to ensure durability and even covering of the layers. The multi-layered material reduces all major sources of heat loss.

The multi-layered blanket material 12 is then outfitted with an attachment member 14. The attachment member 14 may be Velcro™ brand hook-and-loop fasteners (either pieces or a full length member along the entire perimeter), magnetic strips, a zipper, buttons, snaps or any other form of attachment. A first portion of the attachment member 16 is connected to the second side 34 of the multi-layered blanket material 12 and a second portion of the attachment member 18 is connected to a surface 30, such as the surrounding area of an attic access opening 28. The second portion of the attachment member 18 is preferably placed beyond the opening 28 of the door, window or other element to be sealed.

A homeowner can easily install the insulating cover device 10 over an existing opening, gap or doorway 28. First, the second portion of the attachment member 18 is connected or applied to a surface 30 surrounding the opening 28. The second attachment member 18 may have a sticky back, which is pressed around the opening 28 or may otherwise be attached to the area surrounding the opening 28 by other known means such as nails, screws, staples, glue of the like. Then, the first portion of the attachment member 16, which has been previously attached to the multi-layered blanket material 12, is attached to the second portion of the attachment member 18. The attachment member 14 forms a secure seal that is not easily penetrated by air, but which is not permanent.

In one example, the insulating cover device 10 is designed to cover an attic access opening 28. The insulating cover device 10 completely seals off the attic access opening, which reduces or eliminates the air leakage through the opening door itself as well as though any crack or opening surrounding the door 28, and which increases the R value of the door or opening.

While it is contemplated that the insulating cover device 10 will provide a simple and cost effective solution to insulate the opening of an attic access, the invention is not limited to this application. The invention contemplates the use of the insulating cover device 10 over attic scuttle holes, windows, doorways, knee wall doors, access panels, electrical boxes, and any other place that would benefit from an insulating cover device that can be easily installed and removed as necessary.

Modifications and substitutions by one of ordinary skill in the art are considered to be within the scope of the present invention.

The invention claimed is:

1. An insulating device comprising:
a blanket material that includes a plurality of layers;
a first portion of a two part attachment member, disposed along an outer edge of a first side of the blanket material, wherein the first portion of the attachment member is configured to couple with a second portion of a two part attachment member a second portion of said two part attachment member, disposed on a surface surrounding an outer edge of an opening to be insulated, wherein the first portion of the attachment member and the second portion of the attachment member are configured to couple to form a secure, not permanent seal around said outer edge of said opening.

2. The insulating device of claim 1, wherein the plurality of layers includes at least four layers.

3. The insulating device of claim 2, wherein one of the layers is constructed from a layer of reflective polyethylene that provides a vapor proof barrier.

4. The insulating device of claim 3, wherein the reflective polyethylene layer is a metalized poly film with air-trapping fibers.

5. The insulating device of claim 1, wherein one of the layers is a hollow polyester fiber material that resists heat conduction.

6. The insulating device of claim 1, wherein the insulating device provides at least an R value of 5.

7. The insulating device of claim 1, wherein the plurality of layers include a layer of reflective polyethylene, a hollow polyester fiber material, an inner layer and an outer layer.

8. The insulating device of claim 7, wherein the plurality of layers are quilted together.

9. The insulating device of claim 1, wherein the two part attachment member is selected from the group consisting of a hook-and-loop fastener, a magnetic strip fastener, a zipper, buttons, and snaps.

10. The insulating device of claim 1, wherein the second portion of the attachment member further includes a sticky backside, wherein the sticky backside is configured to attach to the surface surrounding the outer edge of the opening.

11. The insulating device of claim 1, wherein the insulating device is configured to cover an opening, gap or doorway.

12. The insulating device of claim 11, wherein the opening is selected from the group consisting of an access opening or panel, a window, a doorway, and a knee wall opening.
